(19) United States
(12) Patent Application Publication
(10) Pub. No.: US 2009/0327300 A1
(43) Pub. Date: Dec. 31, 2009

(54) MANIFEST-BASED ENHANCED PRESENCE PUBLISHING

(75) Inventors: Adarsh Khare, Issaquah, WA (US); Stephane Taine, Redmond, WA (US); Venky Venkateshaiah, Bothell, WA (US); Krishnamurthy Ganesan, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/146,501

(22) Filed: Jun. 26, 2008

(51) Int. Cl. G06F 17/30

(52) U.S. Cl. 707/10; 707/E17.032

(57) ABSTRACT

Architecture that facilitates the formalization of contracts across multiple points of presence of a given user so that the multiple presence points can harmoniously publish presence. Enhanced presence publishing rules are formalized as a contract by all the endpoints of a given infoworker. An infoworker can signed on from different releases of software endpoints and to have a consistent presence experience. The infoworker can modify the publishing rules contract in a discoverable fashion by the other infoworker software endpoints. A container contract is provided having default container memberships (presence levels) and static publications. The rules associated with setting and verifying consistency of the default presence store container memberships (presence levels) is formalized. Additionally, the rules associated with making static publications at first time software endpoint registration and verifying consistency of the static publications at subsequent endpoint bootstrapping are formalized.

### BACKGROUND

Presence servers are being deployed in increasing numbers to provide a mechanism for determining the online availability of a user or user system. Thus, the communications between users and/or user systems can be made more effective thereby improving efficiency and productivity. This presence information identifies the current presence state of a user and/or user system, thereby making user presence determinable via the presence server. Users can then decide how best to communicate with other users based on the presence information.

A presence entity either publishes presence data or subscribes to presence data. In a messaging context, a publishing user (or publisher) provides presence information to a presence server, which then provides the presence information to subscribing users (or subscribers). In other words, a presence server framework can employ a subscriber/publisher model to provide the presence information for the entities of the presence service.

Inbetween the publisher and the subscriber is a presence store as a database with a number of accounts for different users. The presence store authorizes responses to the subscriber and authorizes the subscription. The presence store operates on the rules defined by the publisher and shields the publisher from the subscribers. Computing devices can publish presence data and one publisher may be using multiple such devices at any given point in time, such as a device at home, a device at work, a cell phone whether for mobile communications or email or variety of devices that are capable of publishing presence. In such situations, a device needs to be good citizen with respect to the other devices of a single publisher. However, there are no rules that are consistent from one device to the other.

### SUMMARY

The following presents a simplified summary in order to provide a basic understanding of some novel embodiments described herein. This summary is not an extensive overview, and it is not intended to identify key/critical elements or to delineate the scope thereof Its sole purpose is to present some concepts in a simplified form as a prelude to the more detailed description that is presented later.

To that end, the disclosed architecture facilitates the formalization of a manifest (also referred to as a contract) across multiple points of presence of a given user so that the multiple presence points can harmoniously publish presence. Enhanced presence publishing rules are formalized in a manifest used as the contract by all the endpoints of a given infoworker. The architecture also provides the ability for the infoworker to be signed on from different releases of software endpoints and to have a consistent presence experience. The infoworker can modify the publishing rules manifest in a discoverable fashion by the other infoworker software endpoints. A mechanism is provided for applications to discover and select (e.g., based on manifest version) the corresponding publishing rules manifest for use. Additionally, a mechanism is provided to create multiple publishing rules profiles for other applications and provides third-party developers with the ability to extend the default enhanced presence publishing rules manifest in an interoperable fashion.

In addition to the publishing rules manifest, a container manifest is provided having default container memberships (presence levels) and static publications. The rules associated with setting and verifying consistency of the default presence store container memberships (presence levels) is formalized. Additionally, the rules associated with making static publications at first time software endpoint registration and verifying consistency of the static publications at subsequent endpoint bootstrapping are formalized. A mechanism for communications applications to discover and select the corresponding container manifest is also provided.

To the accomplishment of the foregoing and related ends, certain illustrative aspects are described herein in connection with the following description and the annexed drawings. These aspects are indicative of the various ways in which the principles disclosed herein can be practiced, all aspects and equivalents of which are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented system for presence processing in accordance with the disclosed architecture.

FIG. 2 illustrates an exemplary server having components of the system of FIG. 1.

FIG. 3 illustrates creation of a new profile having an XML publishing rules contract and an XML container contract.

FIG. 4 illustrates a SIP signal flow diagram of a translated publication using an XML publishing rules contract.

FIG. 5 illustrates a signal flow diagram of an XML publishing rules update that gets propagated to the other endpoints of a user.

FIG. 6 illustrates a method of presence processing.

FIG. 7 illustrates a method of presence processing.

FIG. 8 illustrates a block diagram of a computing system operable to execute enhanced presence publishing in accordance with the disclosed architecture.

FIG. 9 illustrates a schematic block diagram of an exemplary computing environment that supports enhanced presence publishing in accordance with the disclosed architecture.

### DETAILED DESCRIPTION

Presence is a technology that facilitates the instant determination of the ability (e.g., device capability), availability, and willingness of a user to communicate (e.g., over an IP network). This is manifested as a presence status such as Available or Away to indicate to watchers (presence entities, as subscribers that receive or fetchers that request, presence information about presence entities from a presence service) whether the user is open or not to communication.

Enhanced presence refers to a presence model that uses categories (e.g., granular pieces of information such as device state, user state, note, etc.)as a way of specifying presence information, and containers as a way to authorize presence entities (e.g., subscribers) to obtain the information. Users publish different categories of data to the server and subscribers can subscribe to different categories published by the user. Arbitrary categories can be exchanged between the subscriber and the publisher. Enhanced presence includes SIP (session initiation protocol) extensions to publish and subscribe to presence information, and specifies access for subscribers. Containers provide the publisher a way to publish data values of the same category to allow different subscribers to view different data values.

Access levels (or presence levels) provide a flexible and more granular control method for authorizing user control over the amount of presence information to be exposed to watchers. For example, access levels can include block, public, company, team, and personal.

Understanding that a single user can have multiple devices (or clients) running concurrently, enhanced presence provides a presence status that can be obtained as an aggregation of inputs from various user sources such as phone state, machine state, user settings, applications, and user activities. The multiple devices or multiple points of presence can include IP phones and office communications applications.

As used herein, office communications applications are intended to include an office communications client integrated as part of an office suite of applications, web access communications clients, and communications clients for cell phones and IP phones, for example.

As used herein, a container is a data model that holds published presence information and a list of subscribers that are allowed to access this information. Containers can include system-level containers, public container, blocked container, company container, team container, and personal container, for example. A public container designates a presence store container of publisher data that can be subscribed to by eligible watchers.

Each container is assigned a presence level that determines the eligible watchers that can subscribe to the data published in this container. For example, the public presence level contains the watchers of a public instant messaging cloud, the blocked presence level of malicious watchers, etc. Office communications applications use presence levels to publish more or less data with different levels of accuracy (e.g., blocked watchers can see the infoworker offline even when actually online).

The disclosed architecture addresses at least a problem where a custom (third party) enhanced presence publisher needs to understand communications applications and communications server publishing and presence level rules to make meaningful publications. Existing rules are hard-coded in a communications application and the communications server does not provide a discovery mechanism for these clients.

In an example problem related to server publication rules, an infoworker can be signed on from multiple client communications applications at the same time. In order to provide a consolidated view of the infoworker availability, activity, and communication capabilities, the communications server requires the client applications to make some publications into specific input containers so that the server can aggregate and publish the output of the aggregation algorithm in public containers. There is no discovery mechanism available to third party clients so that these clients can determine where to publish the presence categories that need to get aggregated.

In another example problem related to existing office communications application publication rules, each presence category publication requires a version, a type (e.g., an endpoint, time, user-bound or static), an instance identifier, and a container identifier. Different publication rules govern the publication of different categories. For example, category “foo” instance 1 may need to be published in containers 1, 2, 3 and 4, while category “foo” instance 2 may only need to be published in container 4. When an infoworker's office communications applications publish the same version of the same category instance at the same time, conflict resolution takes place. Category “foo1” may be endpoint-bound, when category “foo2” may be user-bound. When publishing category “foo3”, the office communications applications enforces a specific throttling logic. Office communications applications currently hard-code publication-similar rules, which makes it virtually impossible for a third party to adhere to the same rules when creating a custom client that aims at interoperating with other office communications applications.

In yet another example problem related to presence level rules, the interoperability of a given end user's office communications applications of different releases is not possible when publishing and presence level rules vary from one release to the other. After a server upgrade, the infoworker must upgrade all prior version office communications applications, which entails delays in the roll-out of these new features.

In a final example problem, the personalization of the publishing and presence-level rules by the infoworker or the customization by an administrator is not possible. For example, because the publishing and presence-level rules are currently hard-coded in the office communications applications, the infoworker cannot fine tune these rules for a better fit, such as for changing what is published in a specific presence level (e.g., calendar data, etc). Additionally, an administrator cannot change office communications applications hard-coded publication rules to better fit the current enterprise policies.

The disclosed architecture provides the formalization of a manifest (also referred to as a contract) across multiple points of presence of a given user so that the multiple presence points can harmoniously publish presence. Enhanced presence publishing rules are formalized in a manifest used as the contract by all the endpoints of a given infoworker. The architecture also provides the ability for the infoworker to be signed on from different releases of software endpoints and to have a consistent presence experience. The infoworker can modify the publishing rules manifest in a discoverable fashion by the other infoworker software endpoints. A mechanism is provided for applications to discover and select (e.g., based on manifest version) the corresponding publishing rules manifest for use. Additionally, a mechanism is provided to create multiple publishing rules profiles for other applications and provides third-party developers with the ability to extend the default enhanced presence publishing rules manifest in an interoperable fashion.

In addition to the publishing rules manifest, a container manifest is provided having default container memberships (presence levels) and static publications. The rules associated with setting and verifying consistency of the default presence store container memberships (presence levels) is formalized. Additionally, the rules associated with making static publications at first time software endpoint registration and verifying consistency of the static publications at subsequent endpoint bootstrapping are formalized. A mechanism for communications applications to discover and select the corresponding container manifest is also provided.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

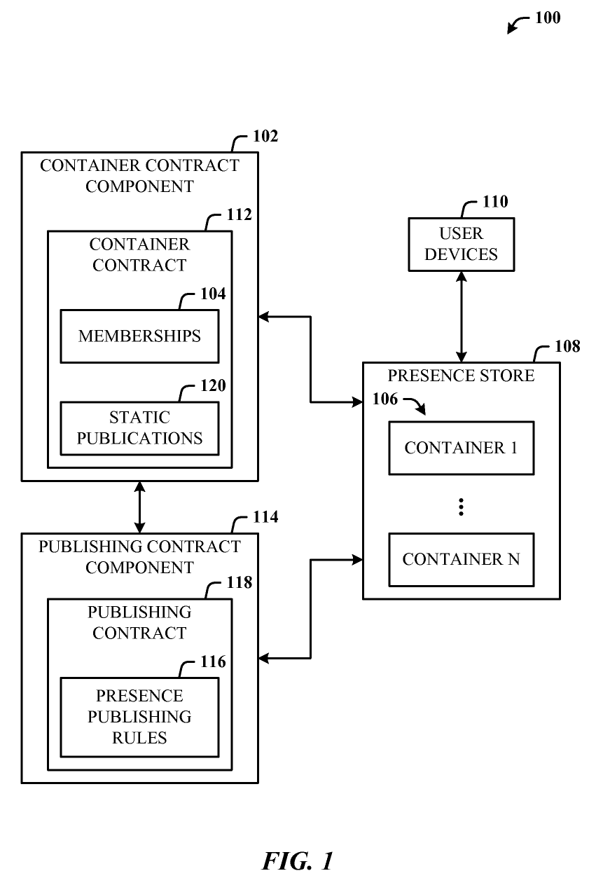

FIG. 1 illustrates a computer-implemented system 100 for presence processing in accordance with the disclosed architecture. The system 100 includes a container contract component 102 for defining container memberships 104 to containers 106 of a presence store 108 for multiple devices 110 of a user. The container memberships 104 are formalized as a container contract 112. The system 100 also includes a publishing contract component 114 for defining presence publishing rules 116 for publishing content to the containers 106 from the multiple devices 110. The presence publishing rules 116 are formalized as a publishing contract 118. The container contract component 102 can further formalize static publications 120 as part of the container contract 112.

Following is a description of benefits gained by the disclosed architecture. When developing a custom interoperable enhanced presence publisher application, a third party application writer can remain agnostic of presence category publication rules. The writer simply updates or sets the content of a presence category and publishes the content. More specifically, the application writer no longer needs to know the following: into how many instances a presence category must be broken down before the presence category can be published; if the category publications are endpoint, user, time-bound or static; to which presence store container(s) the instances shall be published (this includes the presence category that is aggregated by the communications server); what to do in case of version conflict; what throttling takes place for a specific category publication; what are the default presence container memberships (presence levels) that are to be applied at first time login or verified when bootstrapping the office communications application endpoint; and what are the default static publications that are made at first-time login or verified when bootstrapping the office communications application endpoint.

Another benefit is that an infoworker no longer needs to have all endpoints upgraded to the latest release to use the latest office communications applications when publishing and presence level rules have changed from one release to the next. The infoworker can be signed on from different releases of office communications applications and have a consistent experience. For example, if in Release N-1, “Foo” category was published in container 1 and now needs to be published in container 2 to interoperate with Release N, Release N-1 communications applications are able to automatically discover and adjust to Release N publishing and presence level rules, and start publishing “Foo” category in container 2 (this is simplified to illustrate the concept).

Yet another benefit is that the infoworker can personalize the publishing content on a presence level basis. For example, the infoworker can choose to publish a cell phone number in the public presence level although this may not be performed done by office communications applications by default.

Still another benefit is that an administrator can edit the publishing and presence level rules at the communications server and modify these rules so that office communications applications can discover the modifications and adhere to corporate enhanced presence publishing preferences or policies. For example, the company Contoso does not want that members of presence level “Team” access calendar information of an infoworker. The administrator can edit the enhanced presence contract (or manifest) and perform the update. None of the office communications clients will publish calendar data into the “Team” container thereafter.

Another benefit is that one user (e.g., administrator, independent software vendor (ISV), developer, etc) can edit and create new enhanced presence manifest profiles that are relevant to an enhanced presence publishing application other than office communications applications.

For example, Company, Inc., is an ISV that has developed an instant messaging robot that needs to appear online at all times and to advertise that it is a robot. The robot only needs to have one presence level and does not need the communications server to aggregate the robot's presence. A default office communications application manifest can be too complex and not appropriate for the needs of instant messaging robot. Company can simply use a server man-machine command (MMC) interface to create a new manifest profile that will be discovered by its instant messaging robot.

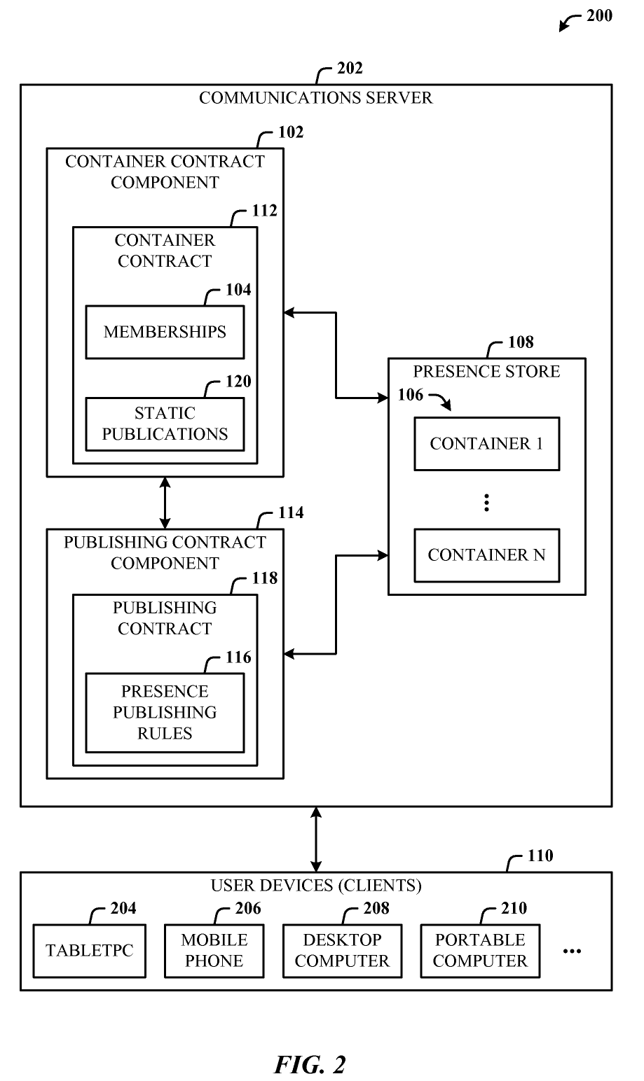

FIG. 2 illustrates an exemplary server 200 having components of the system 100 of FIG. 1. In this embodiment, the server 202 automatically creates the containers 106 when a member is added to a publication is made. The system 200 includes the container contract component 102 for defining container memberships 104 and/or static publications 120 to containers 106 of the presence store 108 for multiple devices 110 of a user, and the publishing contract component 114 for defining presence publishing rules 116 for publishing content to the containers 106 from the multiple devices (clients) 110.

The multiple devices 110 can include client applications installed on a tablet PC 204, a mobile phone 206, desktop computer 208, portable computer 210, SIP phone, etc., that facilitate communications according to an enhanced presence protocol. Input from the devices 110 is collected by the server 202, aggregated into a single presence state and activity, and then pushed to the appropriate containers 106. The containers filter the amount of presence information available to each subscriber.

The disclosed architecture comprises two extensible XML schemas as base grammars for the enhanced presence publishing rules contract and the default container memberships and static publications contract.

The first schema formalizes all the known enhanced presence publishing rules. A publishing rules contract is an XML object that strictly complies with this schema. Examples of publishing rules include, but are not limited to: automatic instance ID generation on an enhanced presence category name-basis (the contract defines the algorithm to be used to generate the instance ID), automatic expiry type identification on an enhanced presence category name-basis (the contract defines if the category is bound to the endpoint registration, to time, to the user/contact registration or is static), allow category instance version conflict resolution based on the “last client wins” logic, and publication type (e.g., simple publication, split publication, translated publication, and static publication).

The second schema formalizes the default presence level rules with respect to default presence container memberships and static publications. A container manifest (or contract) is an XML object that strictly complies with this schema.

The communications server database stores a list of profiles (e.g., office communications profile, custom application profile, etc.). Each profile is assigned a pair of publishing rules and container contracts.

As previously indicated, new profiles can be created, updated, and removed through the server MMC interface. Similarly, publishing rules contracts and container contracts can be created, edited, or deleted. The server stores a read-only copy of all the default profiles and contracts.

With respect to server manifest discoverability, two in-band provisioning groups are created in the server that allow enhanced presence publishing endpoints (also referred to as devices or clients) to discover respective publishing rules and container contracts. When querying in-band provisioning data (e.g., presence manifest or contract) to the server, a unified communications endpoint, for example, has the ability to request a specific profile that varies from an office communications application to an instant messaging robot, for example.

Office communications development platforms (e.g., an office communications API and unified communications API) upon which are implemented local and third party communications applications can be made manifest-aware. The development platforms expose an API allowing the application writer to query in-band provisioning groups for different profiles. At endpoint registration against the communications server, these platforms can automatically discover respective container contracts and publishing rules contracts. The development platform validates the container contract (against the schema), parse the contract, and use the contract as a script to set the default presence store container access control lists (ACLs) and access control entries (ACEs), and publish static category publications, or verifies that the default presence store container ACLs and ACEs are properly set and that the static category publications are published.

The publishing rules contract is validated (against the schema) and loaded in the publishing engine used by Publish() APIs exposed by the development platform object models. The application writer simply has to supply, in the Publish API, what is called a “primary category” object without be concerned about how many instances of this category will be published, where it will be published, etc.

There can be at least three types of publications: simple, translated and split publication. Simple publications are publications where the primary category content is published to different presence containers with no change. An example is a “Note” category that is published in container 100, 200, 300 and 400 with an instance ID set to zero.

Translated publications are publications where the primary category publication triggers chained publications of one or more categories with the same or different names or content. For example, when a user elects to publish an additional mobile phone number in a UserInformation category, this publication warrants updating a contact card category where the mobile phone number is also published. An XSL (extensible stylesheet language) transform is used to make translated publications.

Split publications are publications where the primary publication is first broken down in multiple instances containing a subset of the full information contained in the primary category, before publishing each instance to different set of containers. For example, the application writer supplies a full contact card primary category that includes personal information such as a cell phone number. Most commonly, the cell phone number is only published in order to be consumed by the infoworker's closest friends or co-workers, but at all costs, not by everyone. XSL transforms are used to select the XML elements that can be published in different presence levels. The publishing engine can resolve category publication version conflicts following the “last client wins” logic. When a conflict occurs, a back-off mechanism is used to avoid glare conditions (e.g., each system blocks the other from connecting due to simultaneous failure detection) and re-publishes after a randomly chosen short period of time.

The development platform for unified communications endpoints also exposes APIs thereby allowing the application writer to overwrite the default publishing rules contract loaded in memory. Rather than modifying the contract itself and publishing the contract in full in the self container so that modifications can be consumed by other endpoints of the infoworker, it is more memory efficient to publish a PublishingRulesDelta category that overwrites sections of the publishing rules contract received from communications server through in-band provisioning.

In other words, there can be provided a computer-implemented system 200 for presence processing that comprises the server presence store 108 for storing containers 106, the container contract component 112 for defining container memberships 104 and static publications 120 to the containers 106 of the presence store 108 for multiple devices 110 of the user. The container memberships 104 and static publications 120 are formalized as a container contract 112. The system 200 can also include the publishing contract component 114 for defining the presence publishing rules 116 for publishing content to the containers 106 from the multiple devices 110. The presence publishing rules 116 are formalized as a publishing contract 118.

The content is personalized on a presence level basis and, the container contract 112 and the publishing contract component 114 facilitate access to the personalized content from the multiple devices 110 of the user. The container contract component 102 and the publishing contract component 114 are employed on the communications server 202 that facilitates discoverability and selection of the publishing contracts 118 by the multiple devices 110. The container contract component 102 and the publishing contract component 114 facilitate server-side creation, updating, and removal of new profiles. The container contract 118 and the publishing contract 118 can be XML objects. The publishing rules 116 define publication types that include simple publication, split publication, translated publication, and static publication.

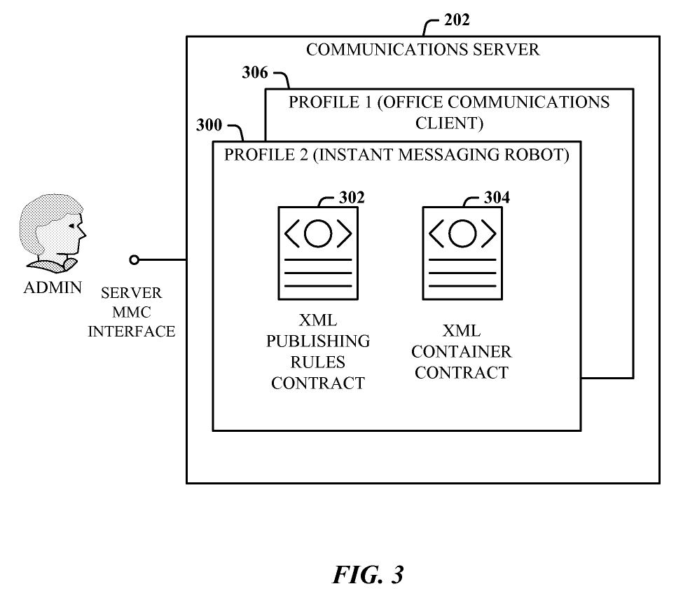

FIG. 3 illustrates creation of a new profile 300 having an XML publishing rules contract 302 and an XML container contract 304. An administrator interacts with the MMC interface to create the new profile 300 for an instant messaging robot, in addition to an existing profile 306 having corresponding publishing and container contracts (not shown).

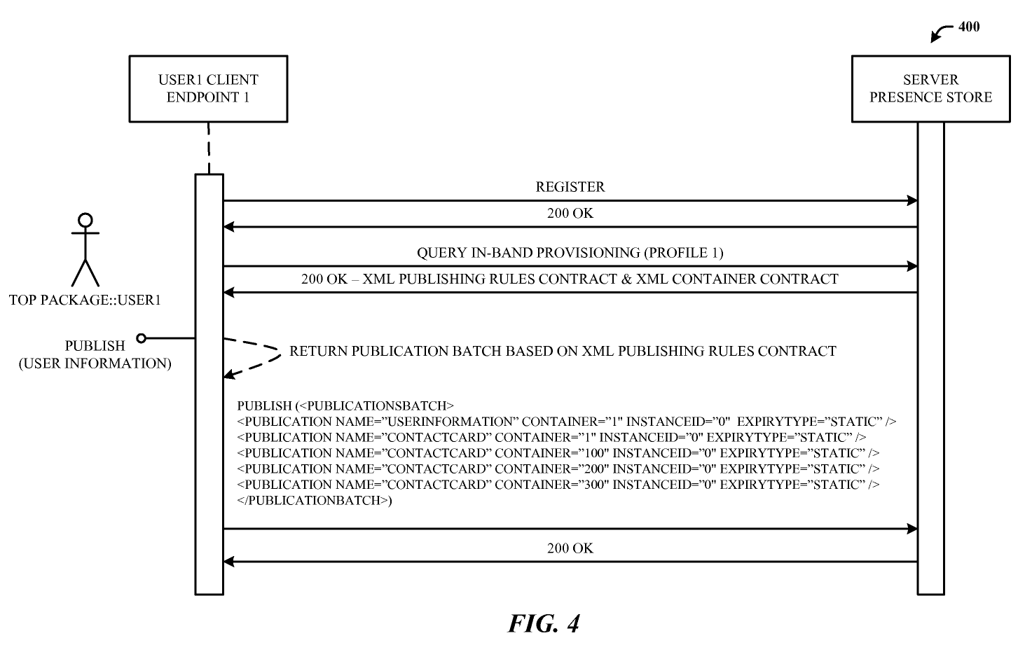

FIG. 4 illustrates a SIP signal flow diagram 400 of a translated publication using an XML publishing rules contract. A User1 client registers to a server presence store to update a user cell phone number. The server presence store responses with a SIP 200 OK. Note that although described in the context of a SIP implementation, other technologies can also be employed. The User1 client sends a query in-band provisioning for a Profile1. The server presence store responds with a 200 OK for an XML publishing rules contract and XML container contract. User1 publishes one primary UserInformation category that triggers batch publishing of contact card category instances to different containers (e.g., 1, 100, 200 and 300). Following is example XML code for this process.

Publish (<PublicationsBatch>
<Publication name=“UserInformation” container=“1” instanceId=“0”
expiryType=“static” />
<Publication name=“ContactCard” container=“1” instanceId=“0”
expiryType=“static” />
<Publication name=“ContactCard” container=“100” instanceId=“0”
expiryType=“static” />
<Publication name=“ContactCard” container=“200” instanceId=“0”
expiryType=“static” />
<Publication name=“ContactCard” container=“300” instanceId=“0”
expiryType=“static” />
</PublicationBatch>)

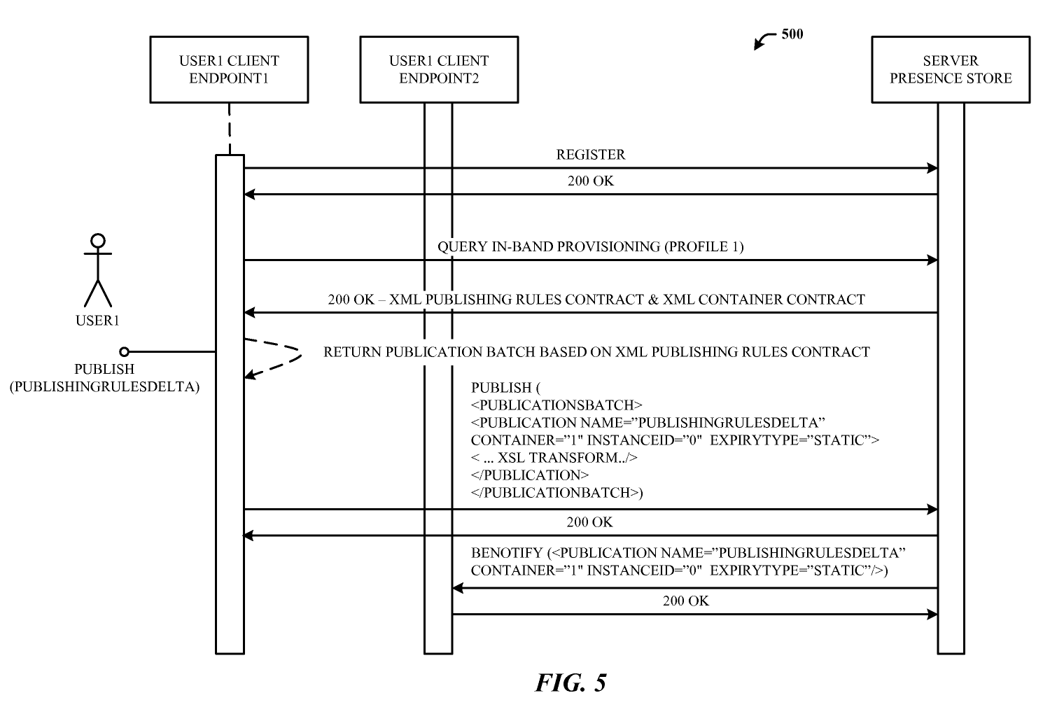

FIG. 5 illustrates a signal flow diagram 500 of an XML publishing rules update that gets propagated to the other endpoints of a user. In this example, the signal flow follows the user updating the content published in a container 200. Initially, a user client endpoint1 (also client1) registers with the server presence store. The presence store replies with a 200 OK. The client1 then issues an in-band provisioning for Profile1 to the server presence store. The server presence store responds with a 200 OK for the XML publishing rules contract and the XML container contract. The user client1 then returns a publication batch based on the XML publishing rules contract. Following is XML content that facilitates the signal flow for this process.

Publish (
<PublicationsBatch>
<Publication name=“PublishingRulesDelta” container=“1” instanceId=“0”
expiryType=“static”>
< ... XSL Transform../>
</Publication>
</PublicationBatch>)

The server presence store returns a SIP 200 OK to client1. The presence store server then sends a BeNotify message with the updated container 200 content to the second user endpoint client2. The second user endpoint client2 replies to the server presence store with a SIP 200 OK, and the update is complete. Where more user endpoints are involved, the server presence store will send additional messages to these other endpoints.

Following is a series of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

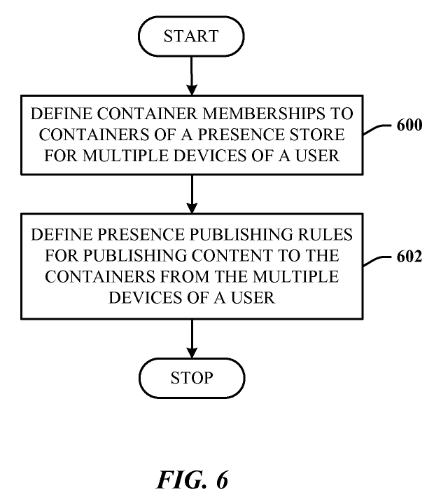

FIG. 6 illustrates a method of presence processing. At 600, container memberships to containers of a presence store are defined for multiple devices of a user. At 602, presence publishing rules for publishing content to the containers from the multiple devices are defined.

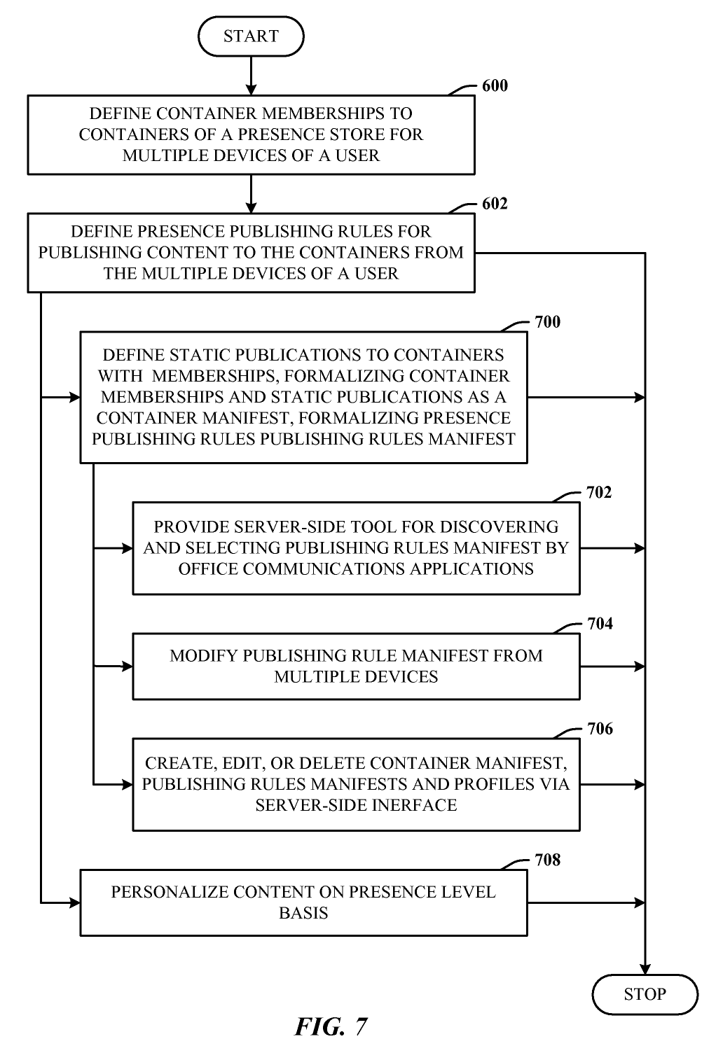

FIG. 7 illustrates a method of presence processing. The method includes the step 600, where container memberships to containers of a presence store are defined for multiple devices of a user, and step 602, where presence publishing rules for publishing content to the containers from the multiple devices are defined. At 700, the content can be personalized on a presence level basis. At 702, static publications to the containers can be defined with the memberships, the container memberships and static publications are formalized as a container manifest, and the presence publishing rules are formalized as a publishing rules manifest. The container manifest and the publishing rules manifest are employed as contracts for the multiple devices of the user.

At 704, a server-side tool is provided for discovering and selecting the publishing rules manifest by office communications applications. At 706, the publishing rules manifest is modified from the multiples devices. At 708, the container manifests, publishing rules manifests, and profiles can be created, edited or deleted via a server-side interface.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

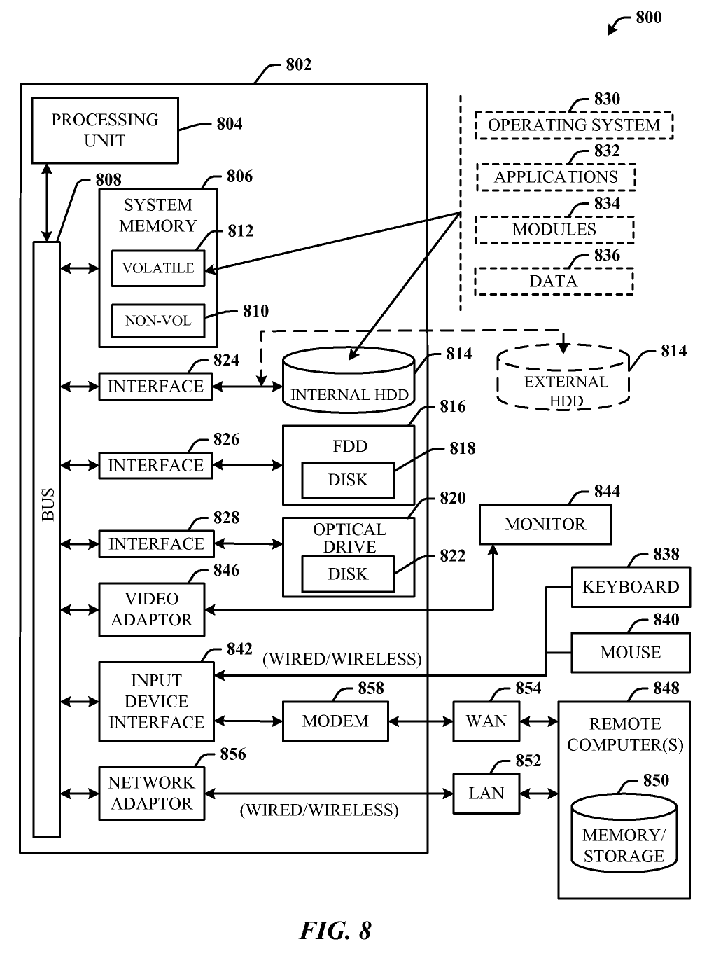

Referring now to FIG. 8, there is illustrated a block diagram of a computing system 800 operable to execute enhanced presence publishing in accordance with the disclosed architecture. In order to provide additional context for various aspects thereof, FIG. 8 and the following discussion are intended to provide a brief, general description of a suitable computing system 800 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 8, the exemplary computing system 800 for implementing various aspects includes a computer 802 having a processing unit 804, a system memory 806 and a system bus 808. The system bus 808 provides an interface for system components including, but not limited to, the system memory 806 to the processing unit 804. The processing unit 804 can be any of various commercially available processors. Dual microprocessors and other multi-processor architectures may also be employed as the processing unit 804.

The system bus 808 can be any of several types of bus structure that may further interconnect to a memory bus (with or without a memory controller), a peripheral bus, and a local bus using any of a variety of commercially available bus architectures. The system memory 806 can include non-volatile memory (NON-VOL) 810 and/or volatile memory 812 (e.g., random access memory (RAM)). A basic input/output system (BIOS) can be stored in the non-volatile memory 810 (e.g., ROM, EPROM, EEPROM, etc.), which BIOS are the basic routines that help to transfer information between elements within the computer 802, such as during start-up. The volatile memory 812 can also include a high-speed RAM such as static RAM for caching data.

The computer 802 further includes an internal hard disk drive (HDD) 814 (e.g., EIDE, SATA), which internal HDD 814 may also be configured for external use in a suitable chassis, a magnetic floppy disk drive (FDD) 816, (e.g., to read from or write to a removable diskette 818) and an optical disk drive 820, (e.g., reading a CD-ROM disk 822 or, to read from or write to other high capacity optical media such as a DVD). The HDD 814, FDD 816 and optical disk drive 820 can be connected to the system bus 808 by a HDD interface 824, an FDD interface 826 and an optical drive interface 828, respectively. The HDD interface 824 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 802, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 812, including an operating system 830, one or more application programs 832, other program modules 834, and program data 836. The one or more application programs 832, other program modules 834, and program data 836 can be associated with the devices 110.

All or portions of the operating system, applications, modules, and/or data can also be cached in the volatile memory 812. It is to be appreciated that the disclosed architecture can be implemented with various commercially available operating systems or combinations of operating systems.

A user can enter commands and information into the computer 802 through one or more wire/wireless input devices, for example, a keyboard 838 and a pointing device, such as a mouse 840. Other input devices (not shown) may include a microphone, an IR remote control, a joystick, a game pad, a stylus pen, touch screen, or the like. These and other input devices are often connected to the processing unit 804 through an input device interface 842 that is coupled to the system bus 808, but can be connected by other interfaces such as a parallel port, IEEE 1394 serial port, a game port, a USB port, an IR interface, etc.

A monitor 844 or other type of display device is also connected to the system bus 808 via an interface, such as a video adaptor 846. In addition to the monitor 844, a computer typically includes other peripheral output devices (not shown), such as speakers, printers, etc.

The computer 802 may operate in a networked environment using logical connections via wire and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wire/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computer 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wire and/or wireless device, is connected to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

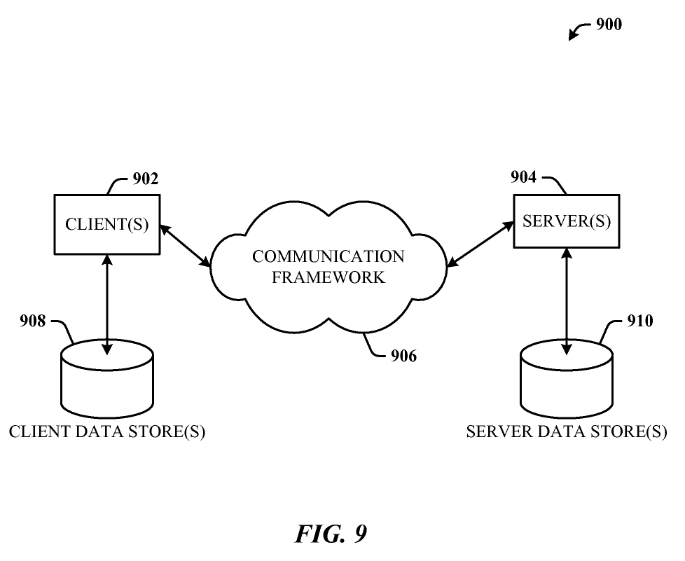

Referring now to FIG. 9, there is illustrated a schematic block diagram of an exemplary computing environment 900 that supports enhanced presence publishing in accordance with the disclosed architecture. The environment 900 includes one or more client(s) 902. The client(s) 902 can be hardware and/or software (e.g., threads, processes, computing devices). The client(s) 902 can house cookie(s) and/or associated contextual information, for example.

The environment 900 also includes one or more server(s) 904. The server(s) 904 can also be hardware and/or software (e.g., threads, processes, computing devices). The server(s) 904 can house threads to perform transformations by employing the architecture, for example. One possible communication between a client 902 and a server 904 can be in the form of a data packet adapted to be transmitted between two or more computer processes. The data packet may include a cookie and/or associated contextual information, for example. The environment 900 includes a communication framework 906 (e.g., a global communication network such as the Internet) that can be employed to facilitate communications between the client(s) 902 and the server(s) 904.

Communications can be facilitated via a wire (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904. The server(s) 904 can includes the communications server 202 and the client(s) 902 can include the devices 110 and associated device clients.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system for presence processing, comprising:
a container contract component for defining container memberships to containers of a presence store for multiple devices of a user, the container memberships formalized as a container contract; and
a publishing contract component for defining presence publishing rules for publishing content to the containers from the multiple devices, the presence publishing rules formalized as a publishing contract.

2. The system of claim 1, wherein the container contract component further formalizes static publications as part of the container contract.

3. The system of claim 2, wherein the static publications are made at first-time registration of a client communications application and consistency of the static publications is verified at subsequent bootstrapping of the client communications application.

4. The system of claim 1, wherein the container contract and the publishing contract facilitate access to the content from different versions of communication applications.

5. The system of claim 1, wherein the publishing contract is discoverable for modification via other user communications applications.

6. The system of claim 1, wherein the content is personalized on a presence level basis.

7. The system of claim 1, wherein the container contract component and publishing contract component facilitate server-side creation of a profile having a new container contract and a new publishing contract.

8. The system of claim 1, wherein the container contract component and publishing contract component are employed on a communications server to facilitate discoverability and selection of publishing contracts by corresponding client communications applications.

9. A computer-implemented system for presence processing, comprising:
a server presence store for storing containers;
a container contract component for defining container memberships and static publications to containers of the presence store for multiple devices of a user, the container memberships and static publications formalized as a container contract; and
a publishing contract component for defining presence publishing rules for publishing content to the containers from the multiple devices, the presence publishing rules formalized as a publishing contract.

10. The system of claim 9, wherein the content is personalized on a presence level basis and, the container contract and the publishing contract facilitate access to the personalized content from the multiple devices of the user.

11. The system of claim 9, wherein the container contract component and publishing contract component are employed on a communications server that facilitates discoverability and selection of publishing contracts by the multiple devices.

12. The system of claim 9, wherein the container contract component and publishing contract component facilitate server-side creation, updating, and removal of new profiles.

13. The system of claim 9, wherein the container contract and the publishing contract are XML objects.

14. The system of claim 9, wherein the publishing rules define publication types that include simple publication, split publication, translated publication, and static publication.

15. A computer-implemented method of presence processing, comprising:
defining container memberships to containers of a presence store for multiple devices of a user; and
defining presence publishing rules for publishing content to the containers from the multiple devices.

16. The method of claim 15, further comprising personalizing the content on a presence level basis.

17. The method of claim 15, further comprising defining static publications to the containers with the memberships, formalizing the container memberships and static publications as a container manifest, and formalizing the presence publishing rules as a publishing rules manifest, the container manifest and the publishing rules manifest employed as contracts for the multiple devices of the user.

18. The method of claim 17, further comprising providing a server-side tool for discovering and selecting the publishing rules manifest by office communications applications.

19. The method of claim 17, further comprising modifying the publishing rules manifest from the multiples devices.

20. The method of claim 17, further comprising creating, editing or deleting container manifests, publishing rules manifests, and profiles via a server-side interface.
